(19) United States
(12) Patent Application Publication
(10) Pub. No.: US 2026/0351936 A1
(43) Pub. Date: Nov. 5, 2026

(54) INTERCHANGEABLE COLOR TRIM

(71) Applicant: Hubbell Incorporated, Shelton, CT (US)

(72) Inventors: Stephen Michael Boener, Goshen, IN (US); Jonathan Randall Falls, Gilbert, AZ (US); Jace Robert Lee Matteson, Granger, IN (US); Krishna C. Patel, Granger, IN (US)

(21) Appl. No.: 19/657,619

(22) Filed: Apr. 24, 2026

Related U.S. Application Data
(60) Provisional application No. 63/797,408, filed on Apr. 30, 2025.

(51) Int. Cl. H02G 3/08; G09F 7/00

(52) U.S. Cl. CPC H02G 3/081; G09F 7/00

(57) ABSTRACT

An electrical device cover includes a base, a flexible element coupled to the base and movable between an expanded position and a collapsed position, an outer base removably coupled to the base, and a faceplate removably coupled to the flexible element. The faceplate can at least partially enclose the base in the collapsed position of the flexible element. At least one of the outer base and the faceplate include a marking that can communicate information about the electrical device cover.

### CROSS-REFERENCE TO RELATED APPLICATION

This claims the benefit of U.S. Provisional Application No. 63/797,408, filed Apr. 30, 2025, the contents of which is incorporated herein by reference in its entirety.

### FIELD

The present disclosure relates to an electrical box cover. More particularly, the present disclosure relates to an interchangeable trim for an electrical box cover.

### BACKGROUND

Electrical devices are prone to exposure to water and other contaminants when mounted in locations such as exterior walls. Many different cover designs seek to shield the devices from weather-related contaminants while electrical connectors are or are not coupled with the devices. Covers may have different markings to communicate different information about the cover itself and/or the electrical devices contained within. Covers may be constructed with one type of marking and are not swapable with different markings to enable the covers to be used in different situations.

### SUMMARY

Various examples of the present disclosure can overcome various of the aforementioned and other disadvantages associated with known terminal connectors and offer new advantages as well.

In some forms, there is provided an electrical device cover configured for mounting over an electrical device. The electrical device cover includes a base, a flexible element coupled to the base and movable between an expanded position and a collapsed position, an outer base removably coupled to the base, and a faceplate removably coupled to the flexible element. The faceplate can at least partially enclose the base in the collapsed position of the flexible element. At least one of the outer base and the faceplate include a marking that can communicate information about the electrical device cover.

In some forms, there is provided an electrical device cover configured for mounting over an electrical device. The electrical device cover includes a base, a cover coupled to the base and movable between an opened position and a closed position, and a faceplate removably coupled to the cover. The faceplate at least partially covers an outer surface of the cover. The faceplate includes a marking that can communicate information about the electrical device cover.

In some forms, there is a kit of an electrical device cover that includes an inner base, a first faceplate, a second faceplate, a first outer base, and a first inner base. The first faceplate and the first outer base include a first marking and make up a first group. The second faceplate and the second outer base make up a second group and include a second marking different than the first marking. One of the first group and the second group is selected and coupled to the first inner base.

In some forms, there is provided a method of identifying an electrical device cover. The method includes selecting one of a first faceplate and a second faceplate. The first faceplate includes a first marking and the second faceplate includes a second marking different than the first marking. The method also includes connecting the selected one of the first faceplate and the second faceplate to a flexible element of the electrical device cover. The flexible element is movable between an expanded position that extends beyond a base of the electrical device cover and a collapsed position that is within the volume of the base. The selected one of the first faceplate and the second faceplate can at least partially enclose the base when the flexible element is in the collapsed position.

In some forms, there is provided a method of identifying an electrical device cover. The method includes selecting one of a first faceplate and a second faceplate. The first faceplate includes a first marking and the second faceplate includes a second marking different than the first marking. The method also includes connecting the selected one of the first faceplate and the second faceplate to a cover of the electrical device cover. The cover is movable between an opened position that at least partially exposes an internal volume of a base of the electrical device cover and a closed position that encloses the volume of the base. The selected one of the first faceplate and the second faceplate can at least partially cover an outer surface of the cover.

In some forms, there is a method of identifying an electrical device cover. One of a first faceplate and a second faceplate is selected. The first faceplate includes a first marking and the second faceplate includes a second marking different than the first marking. One of a first outer base and a second outer base is selected. The first outer base includes the first marking and the second outer base includes the second. The selected one of the first outer base and the second outer base is connected to an outer surface of an inner base of the electrical device cover. The selected one of the first faceplate and the second faceplate is connected to an inner surface of the inner base. The selected one of the first faceplate and the second faceplate can at least partially cover an outer surface of the cover. The selected one of the first outer base and the second outer base is selected based on the selected one of the first faceplate and the second faceplate. The first marking is an alpha-numeric character, a color, a pattern, and/or a texture.

The disclosure herein should become evident to a person of ordinary skill in the art given the following enabling description and drawings. The drawings are for illustration purposes only and are not drawn to scale unless otherwise indicated. The drawings are not intended to limit the scope of the disclosure. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred examples and reference to the accompanying drawing wherein:

FIG. 1 is a perspective view of an electrical box cover in a collapsed position.

FIG. 2 is a perspective view of the electrical box cover of FIG. 1 in an expanded position.

FIG. 3 is a perspective view of the electrical box cover of FIG. 2 with a first plate removed.

FIG. 4 is a cross-sectional view of the electrical box cover of FIG. 3, viewed along section 4--4.

FIG. 5 is a perspective view of an outer cover ring of the electrical box cover of FIG. 1.

FIG. 6 is a perspective view of a first outer cover of the electrical box cover of FIG. 1.

FIG. 7 is a side view of the first outer cover of FIG. 6.

FIG. 8 is a cross-sectional view of the electrical box cover of FIG. 1 with the first outer cover viewed along section 8--8.

FIG. 9 is a perspective view of a second outer cover of the electrical box cover of FIG. 1.

FIG. 10 is a side view of the second outer cover of FIG. 9.

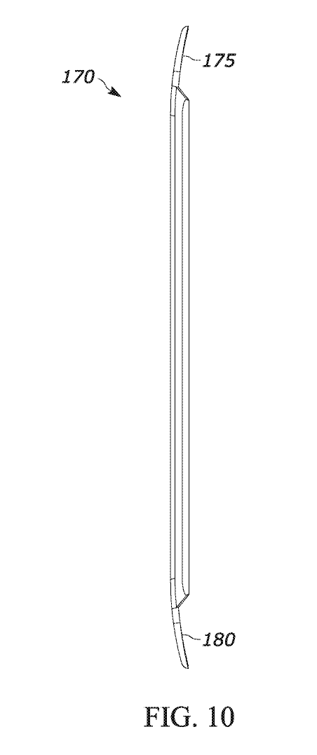

FIG. 11 is a cross-sectional view of the electrical box cover of FIG. 1 with the second outer cover viewed along section 8--8.

FIG. 12 is a perspective view of a first outer cover of the electrical box cover of FIG. 1.

FIG. 13 is a side view of the third outer cover of FIG. 12.

FIG. 14 is a cross-sectional view of the electrical box cover of FIG. 1 with the third outer cover viewed along section 8--8.

FIG. 15 is a perspective view of an alternate example of an electrical box.

FIG. 16 is a front perspective view of a front plate for the electrical box of FIG. 15.

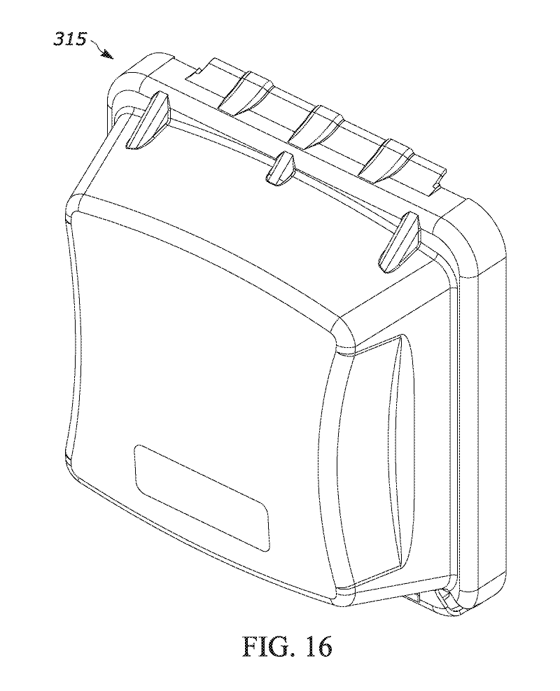

FIG. 17 is a rear perspective view of the front plate of FIG. 16.

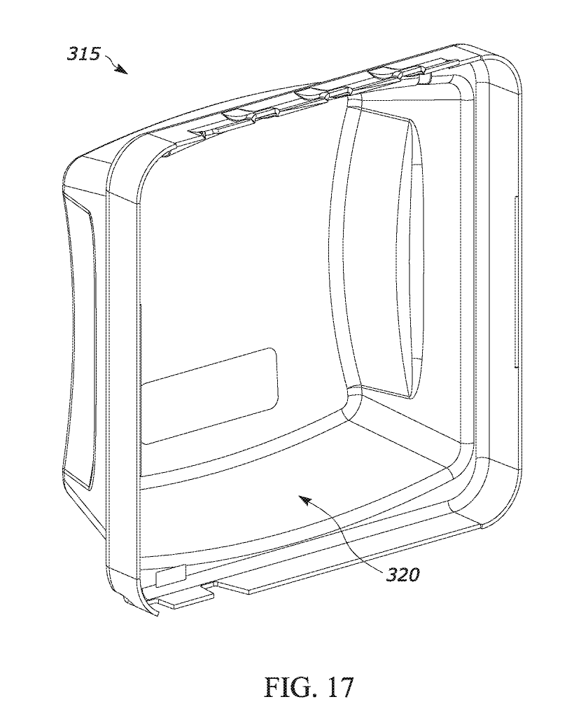

FIG. 18 is a perspective view of the front plate of FIG. 16 coupled to the electrical box of FIG. 15.

### DETAILED DESCRIPTION

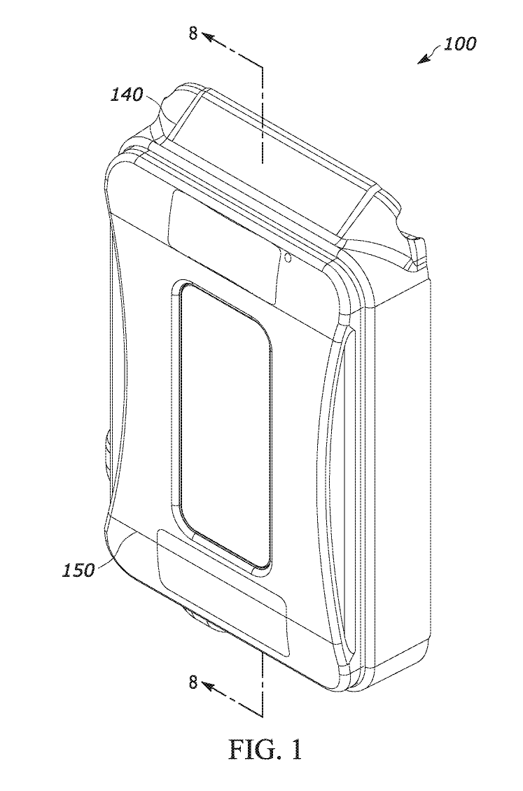

FIGS. 1- 4 illustrate an electrical box cover 100 that can enclose an electrical device. For example, the electrical box cover 100 may limit or prevent liquid from reaching the electrical device housed within the electrical box cover 100. The electrical box cover 100 may include a base 105 and a flexible element 110 disposed radially within the base 105.

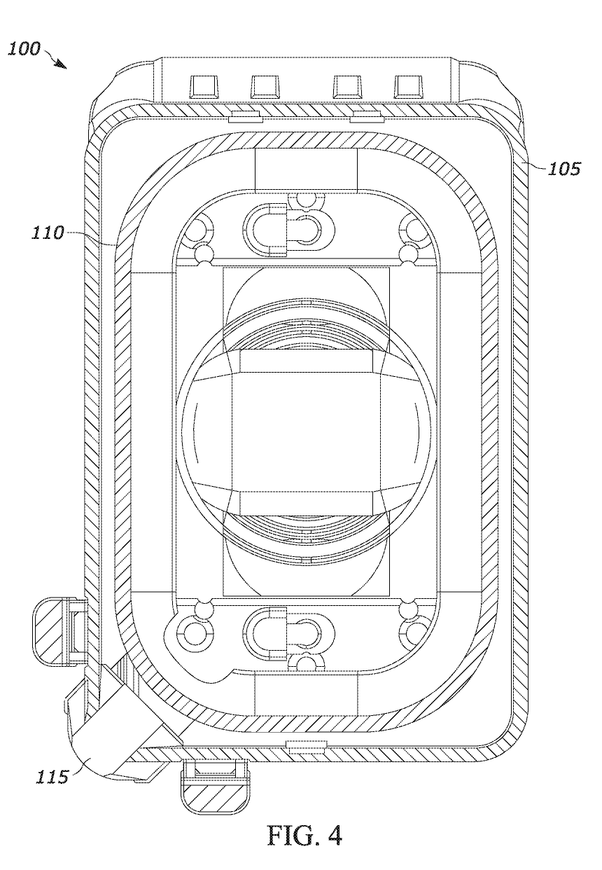

The base 105 may have a complete perimeter and may be open at both the front and the rear. The opening of the base 105 may have a substantially rectangular shape, although other examples of the base 105 may have a different shape. The base 105 may be constructed from a rigid material (e.g., plastic) In some forms, one portion (e.g., a bottom corner) of the base 105 may include a cutout 115 (see e.g., FIG. 4). This may provide a space for a cable (e.g., an electrical conductor) to pass through.

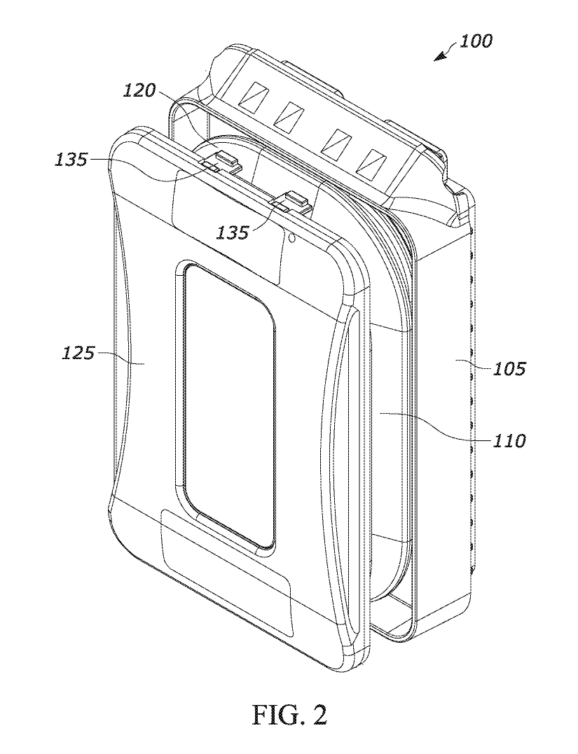

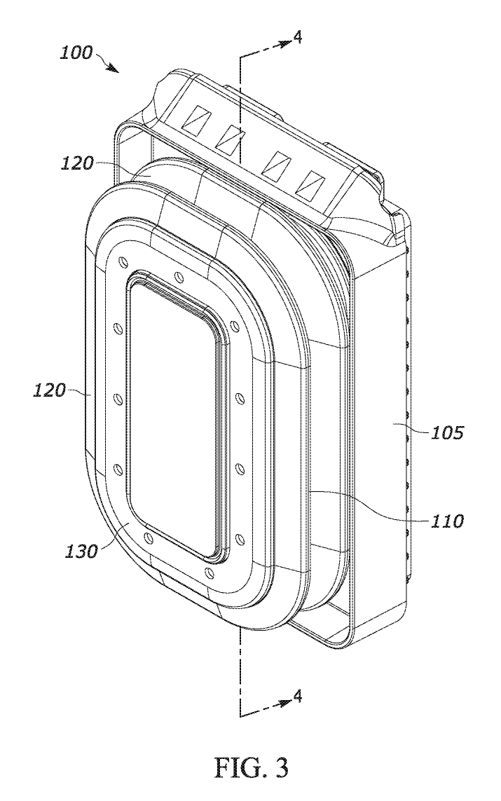

As shown in FIGS. 2 and 3, the flexible element 110 may be connected to an inner wall of the base 105. The flexible element 110 may be constructed from a flexible material (e.g., rubber). In the illustrated example, the flexible element 110 may be constructed with two or more tiers 120. A tier 120 may be disposed radially within an adjacent tier 120, and the tiers 120 may be movable relative to the adjacent tiers 120. This may allow the flexible element 110 to expand or collapse to change a volume of the electrical box cover 100. For example, the flexible element 110 may be pulled away from the base 105, which causes the tiers 120 to expand and increase the volume. Alternatively, the flexible element 110 can be pushed toward the base 105 so that the tiers 120 of the flexible element 110 collapse and decrease the volume. The tiers 120 may be repeatedly expanded and contracted based on the use of the electrical box cover 100.

As shown in FIG. 2, a cover 125 may be coupled to the flexible element 110. More specifically, the cover 125 may be coupled to the smallest (e.g., radially innermost) tier 120 of the flexible element 120. The cover 125 may have a width than the smallest tier 120, and its width may be approximately the size of the opening of the base 105.

As shown in FIG. 3, some forms of the smallest tier 120 may include a connection surface 130. For example, the surface 130 may include one or more openings for receiving a fastener, which can be used to secure the cover 125 to the flexible element 110. Alternatively, the surface 130 may include openings for receiving snap-fit connectors or could include magnets. The cover 125 may have a complementary connection feature to permit connection with the connection surface 130.

The cover 125 may be spaced apart from the base 105 when the flexible element 110 is at least partially in the expanded position (see e.g., FIG. 2). However, when the flexible element 110 returns to the collapsed position (see e.g., FIG. 1), the cover 125 may be positioned within the opening of the base 105 so that there is substantially no gap between the cover 125 and the base 105.

Returning to FIG. 2, the cover 125 may include one or more connection tabs 135 (e.g., two shown) disposed proximate to an outer edge. The connection tabs 135 may engage an inner surface of the base 105 to secure the cover to the base 105 and the flexible element 120 in the collapsed position. In some forms, the engagement between the connection tabs 135 and the base 105 may be a snap fit.

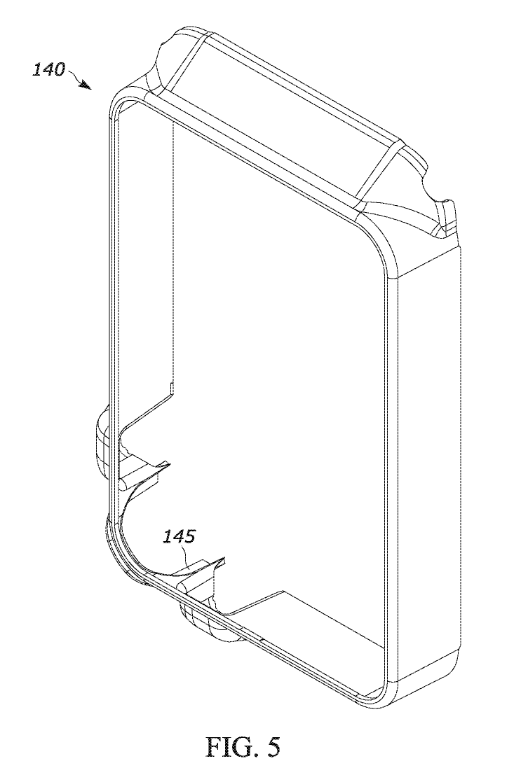

As shown in FIG. 5, an outer base 140 may have a shape similar to the base 105. For example, the outer base 140 may have a closed outer perimeter with an opening at both the front and the rear, which may have a substantially rectangular shape. The outer base 140 may also have a cutout 145 that is similar to the cutout 115. The outer base 140 may connect to an outer surface of the base 105 (e.g., with a snap fit, press fit, friction fit, adhesives, magnets, mechanical fasteners, etc.).

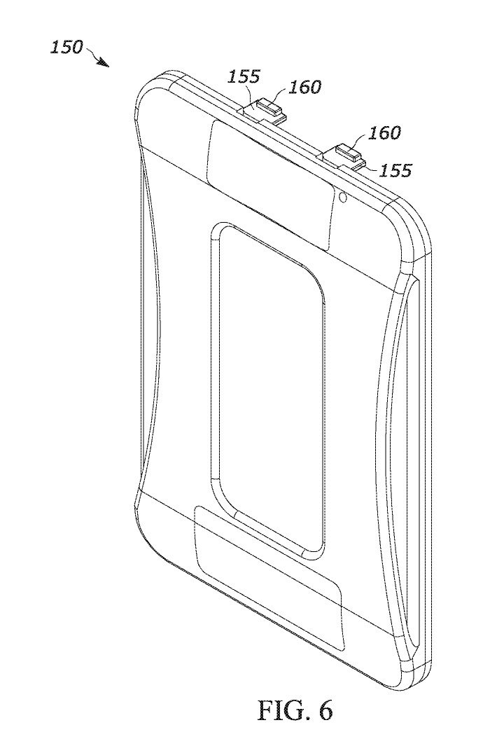

As shown in FIG. 6, a faceplate 150 may have an outer perimeter that is substantially similar to the shape of the cover 125. For example, the faceplate 150 may have a substantially rectangular shape, although other examples of the faceplate 150 may have a different shape. In some forms, the faceplate 150 may be slightly larger than the cover 125 and may correspond to a size of the opening of the outer base 140.

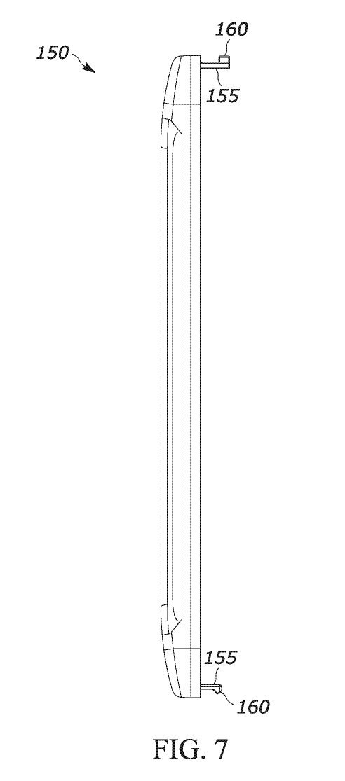

As shown in FIGS. 6 and 7, the faceplate 150 may have one or more fingers 155. In the illustrated example, the faceplate 150 may have a pair of upper fingers 155 and a pair of lower fingers 155, although other numbers or arrangement of fingers 155 may be used in other examples. Each of the fingers 155 may include an overhang 160 that can engage the base 105 in a snap-fit arrangement. The fingers 155 may be similar to the connection tabs 135.

In use, a user may use either the cover 125 or the faceplate 150 as a front surface of the electrical box cover 100. As described above, the cover 125 may be used to provide a front protective surface for the electrical box cover 100 and may be used to secure the flexible element 110 in the collapsed position. The faceplate 150 may serve a similar function but may connect to the body 105 in a different manner than the cover 125.

In some forms, the cover 125 or the faceplate 150 may include a marking or indicia. For example, the cover 125 or faceplate 150 may include alpha-numeric characters, colors, patterns, and/or textures that may communicate information about the electrical box cover 100 or the electrical device contained within. Similarly, the outer base 140 may include alpha-numeric characters, colors, patterns, and/or textures that match the features on the cover 125 or faceplate 150.

A user may replace the cover 125 or faceplate 150 with a similar cover 125 or faceplate 150 with a different marking or indicia, and thus communicating different information. For example, because the cover 125 or faceplate 150 may be connected to the surface 130 using a method (e.g., mechanical connector, snap fit, magnets, etc.) that permits quick connection and removal. In other words, the cover 125 or faceplate 150 may be removed and replaced without fully disassembling the electrical box cover 100.

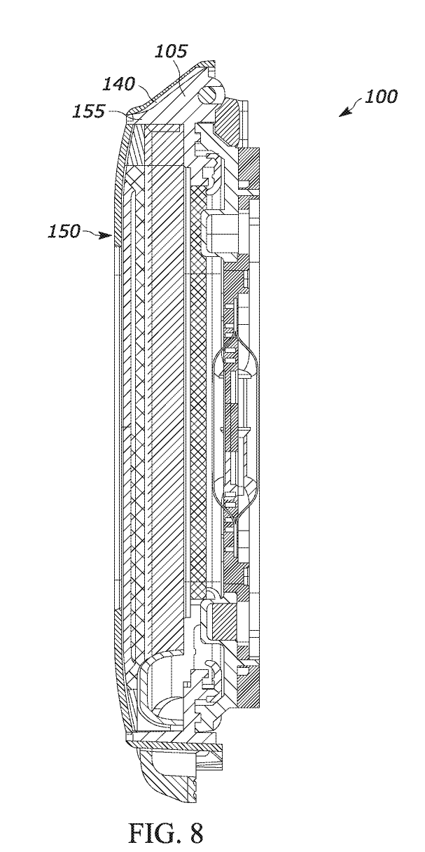

In certain forms, the user may also replace the cover 125 with the faceplate 150 or vice versa. For example, the outer base 140 may be connected around the base 105 (e.g., with a snap fit) and the cover 125 can be removed and replaced with the faceplate 150. As shown in FIG. 8, the fingers 155 of the faceplate 150 may engage an inner surface of the base 105 to secure the faceplate 150 with a snap fit. Different combinations of faceplates 150 and outer bases 140 with different markings (e.g., alpha-numeric characters, colors, patterns, and/or textures) can be used to communicate different information about the electrical box cover 100.

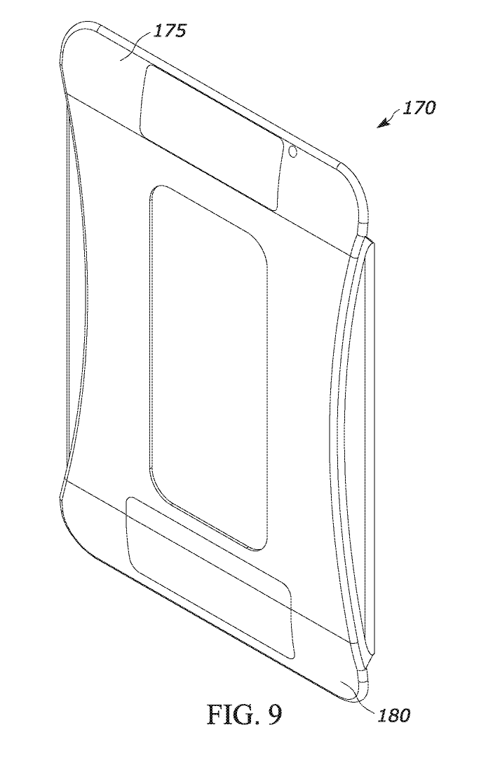

As shown in FIGS. 9 -11, a second example of a faceplate 170 may be similar to the first example of the faceplate 150. For example, the outer perimeter may have a similar rectangular shape (or any other shape that the faceplate 150 may have). However, the faceplate 170 may not include fingers. Instead, an upper end 175 and a lower end 180 of the faceplate 170 may be curved (e.g., as compared to the faceplate 150). This shape may help the faceplate 170 fit within the opening of the base 105 without needing the snap fit fingers.

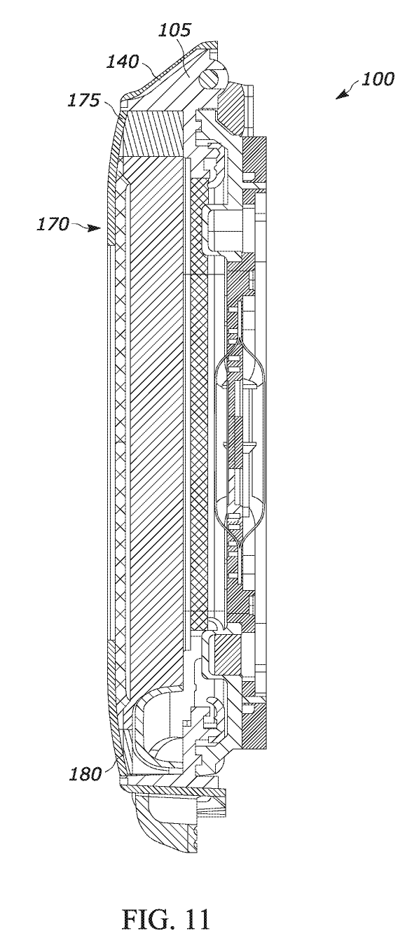

As shown in FIG. 11, the upper and lower ends 175, 180 may not substantially extend along an inner surface of the base 105. Instead, the distance between the upper and lower ends 175, 180 may substantially equate to a distance of the opening of the base 105, so that there is substantially no gap between at edge at either end 175, 180 and the base 105.

In some forms, an adhesive (e.g., glue, double-sided tape, etc.) may be applied to the rear surface of the faceplate 170. The adhesive may permit the faceplate 170 to be quickly connected to the flexible portion 110, and also enables the faceplate 170 to be easily removed. For example, there may be a variety of faceplates 170 with different markings. A user can select a different faceplate 170 with a different marking based on a specific use of the electrical box cover 100. Similarly, the user can match the outer base 140 to a selected faceplate 170.

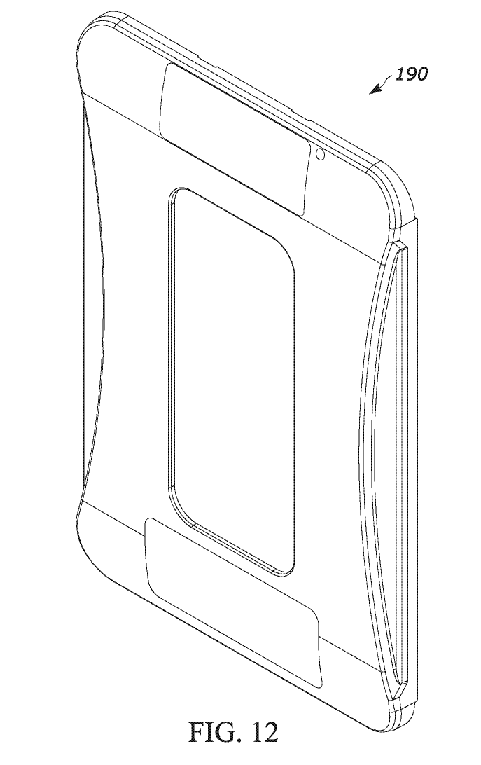

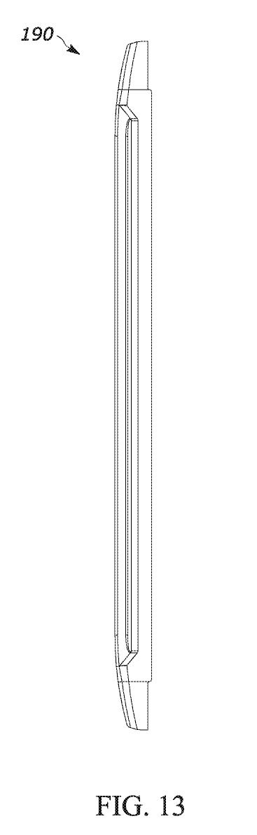

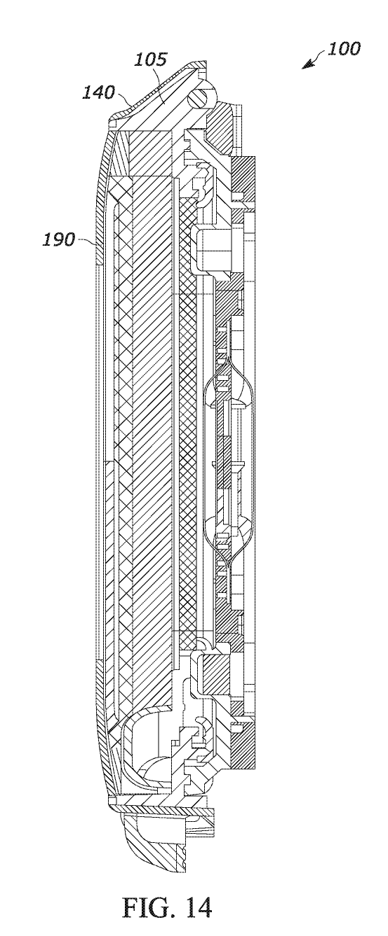

As shown in FIGS. 12-14, a third example of a faceplate 190 may be similar to the first example of the faceplate 150. For example, the outer perimeter may have a similar rectangular shape (or any other shape that the faceplate 150 may have). However, the faceplate 190 may not include fingers (e.g., similar to the faceplate 170). Instead, the faceplate 190 may have a lower profile as compared to the other faceplates. As shown in FIG. 14, the faceplate 190 may include a substantially low profile that does not extend substantially beyond the front of the base 105.

In some forms, the faceplate 190 may be connected to the base 105 using any of the previously described methods (e.g., an adhesive, a snap fit, a press fit, a friction fit, magnets, mechanical fasteners, etc.). This may permit the faceplate 190 to be quickly and easily coupled and removed from the base 105, so that the faceplate 190 is swapable with other faceplates 190 that have different markings. An outer base 140 may be selected to match the markings of the faceplate 190.

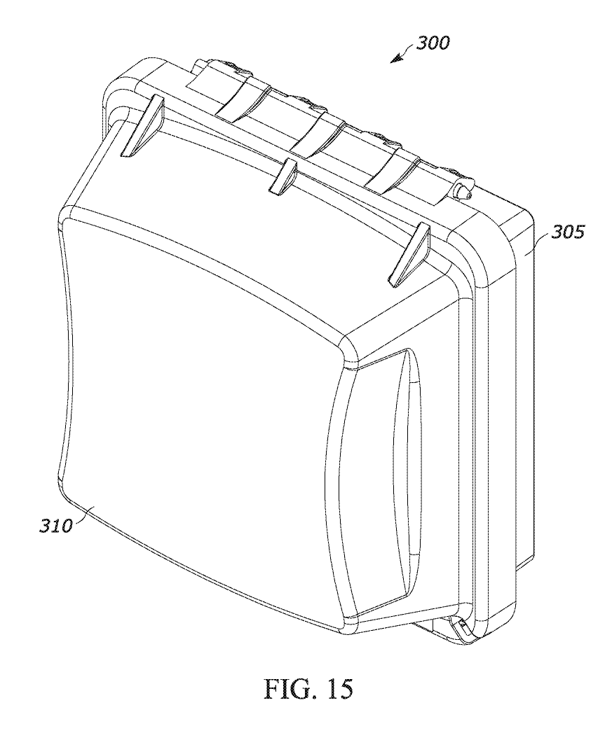

FIGS. 15 - 18 illustrate an alternate example of an electrical box cover 300, which may be similar to the electrical box cover 100. For example, both electrical box covers 100, 300 may be used to house an electrical device. The electrical box cover 300 may have a different shape than the electrical box cover 100 (e.g., square instead of rectangular), although the electrical box cover 300 may have any shape. The electrical box cover 300 may include a base 305 and a lid 310 connected to the base 305.

As shown in FIGS, 16 and 17, a cover 315 may have a shape substantially similar to the shape of the lid 310. For example, the cover 315 may include a cavity 320 that can receive the lid 310.

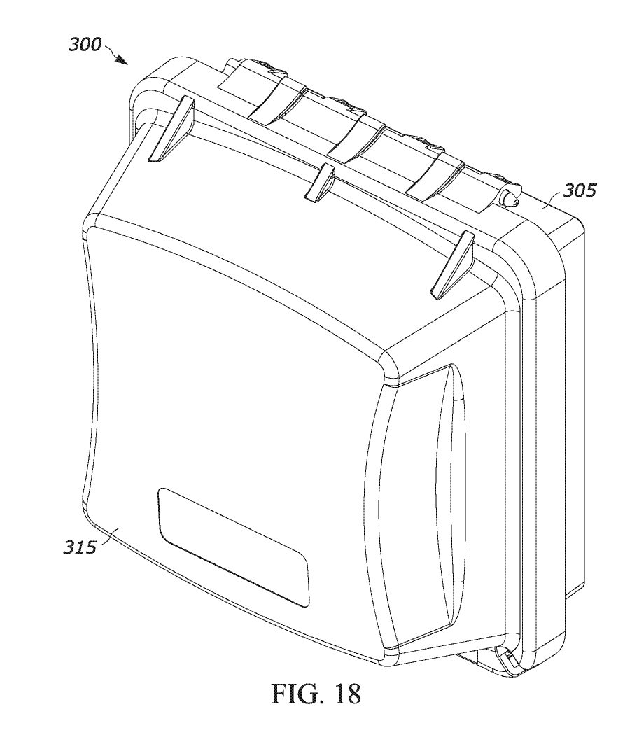

As shown in FIG. 18, the cover 315 may be connected to the lid 310. For example, the cover 315 may be connected using one or more of the above-described connection methods like mechanical fasteners, snap-fit engagement, press-fit engagement, friction-fit engagement, adhesives, and magnets. The cover 315 may include markings (e.g., different alpha-numeric characters, colors, patterns, and/or textures) to communicate to a user-specific features about the electrical box cover 300.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various examples of the disclosure. Once armed with the present specification, routine experimentation is all that is needed to determine adjustments and modifications that will carry out the present disclosure.

The above examples are for illustrative purposes and are not intended to limit the scope of the disclosure or the adaptation of the features described herein. Those skilled in the art will also appreciate that various adaptations and modifications of the above-described preferred examples can be configured without departing from the scope and spirit of the disclosure. Therefore, it is to be understood that, within the scope of the appended claims, the disclosure may be practiced other than as specifically described.

What is claimed is:

1. An electrical device cover configured for mounting over an electrical device, the electrical device cover comprising:
a base;
a flexible element coupled to the base and movable between an expanded position and a collapsed position;
an outer base removably coupled to the base; and
a faceplate removably coupled to the flexible element and configured to at least partially enclose the base in the collapsed position of the flexible element;
wherein at least one of the outer base and the faceplate include a marking that is configured to communicate information about the electrical device cover.

2. The electrical device cover of claim 1, wherein the marking is an alpha-numeric character, a color, a pattern, and/or a texture.

3. The electrical device cover of claim 1 or claim 2, wherein the faceplate includes a finger that has an overhang, and wherein the overhang is configured to selectively engage with the base with a snap fit.

4. The electrical device cover of any one of claims claim 1-3, wherein the faceplate and the flexible element are coupled together with an adhesive.

5. The electrical device cover of any one of claims claim 1- 4, wherein the faceplate and the flexible element are coupled together with a magnet.

6. The electrical device cover of any one of claims claim 1- 5, wherein the base and the outer base are coupled together with an adhesive.

7. The electrical device cover of any one of claims claim 1- 6, wherein the base and the outer base are coupled together with a snap fit.

8. The electrical device cover of any one of claims claim 1-7, wherein the faceplate includes a low profile and does not extend beyond a front edge of the base when the flexible element is in the collapsed position.

9. A method of identifying an electrical device cover, the method comprising:
selecting one of a first faceplate and a second faceplate, wherein the first faceplate includes a first marking and the second faceplate includes a second marking different than the first marking; and
connecting the selected one of the first faceplate and the second faceplate to a flexible element of the electrical device cover, wherein the flexible element is movable between an expanded position that extends beyond a base of the electrical device cover and a collapsed position that is within a volume of the base;
wherein the selected one of the first faceplate and the second faceplate is configured to at least partially enclose the base when the flexible element is in the collapsed position.

10. The method of claim 9, wherein the first marking is an alpha-numeric character, a color, a pattern, and/or a texture.

11. The method of claim 9 or claim 10, further comprising applying an adhesive to a surface of the selected one of the first faceplate and the second faceplate, and connecting the selected one of the first faceplate and the second faceplate to the flexible element using the adhesive.

12. The method of any one of claims claim 9 - 11, wherein the faceplate includes a finger that has an overhang, and wherein the method further includes connecting the overhang to the base with a snap fit when the flexible element is in the collapsed position.

13. The method of any one of claims claim 9 - 12, wherein the faceplate includes a low profile and does not extend beyond a front edge of the base when the flexible element is in the collapsed position.

14. The method of any one of claims claim 9 - 13, wherein connecting the selected one of the first faceplate and the second faceplate to the flexible element uses a magnet.

15. The method of any one of claims claim 9 - 14, wherein connecting the selected one of the first faceplate and the second faceplate to the flexible element uses a mechanical fastener.

16. The method of any one of claims claim 9 -15, further comprising:
selecting one of a first outer base and a second outer base, wherein the first outer base includes a third marking and the second outer base includes a fourth marking different than the third marking; and
connecting the selected one of the first outer base and the second outer base to the base of the electrical device cover.

17. The method of claim 16, wherein the selected one of the first outer base and the second outer base is connected to the base with a snap fit.

18. The method of claim 16 or claim 17, wherein the first marking is the same as the third marking and the second marking is the same as the fourth marking.

19. The method of any one of claims claim 16 -18, wherein the selected one of the first outer base and the second outer base is selected based on the selected one of the first faceplate and the second faceplate.

20. The method of any one of claims claim 9 - 19, further comprising disconnecting the selected one of the first faceplate and the second faceplate from the flexible element and connecting the other of the first faceplate and the second faceplate to the flexible element without disassembling the electrical device cover.

21. An electrical device cover configured for mounting over an electrical device, the electrical device cover comprising:
a base having an internal volume;
a cover coupled to the base and movable between an opened position and a closed position; and
a faceplate removably coupled to the cover and configured to at least partially cover an outer surface of the cover;
wherein the faceplate includes a marking that is configured to communicate information about the electrical device cover.

22. The electrical device cover of claim 21, wherein the marking is an alpha-numeric character, a color, a pattern, and/or a texture.

23. The electrical device cover of claim 21 or claim 22, wherein the faceplate and the cover are coupled together with an adhesive.

24. The electrical device cover of any one of claims claim 21 - 23, wherein the faceplate and the cover are coupled together with an adhesive.

25. The electrical device cover of any one of claims claim 21- 24, wherein the faceplate and the cover are coupled together with a magnet.

26. The electrical device cover of any one of claims claim 21 - 25, wherein the cover is pivotably coupled to the base and wherein the faceplate is configured to pivot with the base.

27. A method of identifying an electrical device cover, the method comprising:
selecting one of a first faceplate and a second faceplate, wherein the first faceplate includes a first marking and the second faceplate includes a second marking different than the first marking; and
connecting the selected one of the first faceplate and the second faceplate to a cover of the electrical device cover, wherein the cover is movable between an opened position that at least partially exposes an internal volume of a base of the electrical device cover and a closed position that encloses the volume of the base;
wherein the selected one of the first faceplate and the second faceplate is configured to at least partially cover an outer surface of the cover.

28. The method of claim 27, wherein the marking is an alpha-numeric character, a color, a pattern, and/or a texture.

29. The method of claim 27 or claim 28, further comprising applying an adhesive to a surface of the selected one of the first faceplate and the second faceplate, and connecting the selected one of the first faceplate and the second faceplate to the cover using the adhesive.

30. The method of any one of claims claim 27 - 29, wherein connecting the selected one of the first faceplate and the second faceplate to a flexible element uses a magnet, wherein the flexible element is movable between an expanded position and a collapsed position.

31. The method of any one of claims claim 27 - 30, wherein the selected one of the first faceplate and the second faceplate is connected to the cover with a snap fit.

32. The method of any one of claims claim 27-31, further comprising disconnecting the selected one of the first faceplate and the second faceplate from a flexible element and connecting the other of the first faceplate and the second faceplate to the cover without disassembling the electrical device cover.

33. A method of identifying an electrical device cover, the method comprising:
selecting one of a first faceplate and a second faceplate, wherein the first faceplate includes a first marking and the second faceplate includes a second marking different than the first marking;
selecting one of a first outer base and a second outer base, wherein the first outer base includes the first marking and the second outer base includes the second;
connecting the selected one of the first outer base and the second outer base to an outer surface of an inner base of the electrical device cover; and
connecting the selected one of the first faceplate and the second faceplate to an inner surface of the inner base;
wherein the selected one of the first faceplate and the second faceplate is configured to at least partially cover an outer surface of the cover; and
wherein the selected one of the first outer base and the second outer base is selected based on the selected one of the first faceplate and the second faceplate.

34. The method of claim 33, wherein the selected one of the first outer base and the second outer base is connected to the base with a snap fit.

35. The method of claim 33 or claim 34, wherein the first marking is an alpha-numeric character, a color, a pattern, and/or a texture.

36. The method of any one of claims claim 33-35, wherein the faceplate includes a finger that has an overhang, and wherein the method further includes connecting the overhang to the inner surface of the inner base with a snap fit.
